(19) United States
(12) Patent Application Publication
(10) Pub. No.: US 2012/0236570 A1
(43) Pub. Date: Sep. 20, 2012

(54) ELECTRONIC APPARATUS

(75) Inventors: Hiroshi Ogomori, Kanagawa (JP); Takashi Ichihara, Kanagawa (JP); Atsushi Seto, Kanagawa (JP)

(73) Assignee: PANASONIC CORPORATION, Osaka (JP)

(21) Appl. No.: 13/514,065

(22) PCT Filed: Sep. 27, 2011
(86) PCT No.: PCT/JP2011/005427

§ 371 Date: Jun. 6, 2012

(30) Foreign Application Priority Data
Sep. 29, 2010 (JP) 2010-218174

(51) Int. Cl. F21V 7/00

(52) U.S. Cl. 362/296.01

(57) ABSTRACT

Display effect is improved. In an electronic apparatus of the present disclosure, an operation body placed in an operation panel of a body case has an operation part inserted into a through hole provided in the operation panel from the rear to the front side, a light reflecting part placed between the outer peripheral surface of a knob forming the operation part and the inner peripheral surface of the through hole and a light emitting part placed behind the light reflecting part. A light guide space is formed between the outer peripheral surface of the knob and the inner peripheral surface of the light reflecting part, and the front side of the light reflecting part is placed behind the operation panel of the body case.

### TECHNICAL FIELD

The invention relates to an electronic apparatus.

### BACKGROUND ART

In a conventional structure, an electronic apparatus includes a body case having an operation panel at the front side thereof, a reproducing device provided in the body case, and an operation body arranged on the operation panel of the body case in order to operate the reproducing device.

The operation body has an operation part which is inserted through a through hole provided in the operation panel of the body case from the rear side of the operation panel to the front side of the operation panel, and a light emitting part which is placed behind the operation part. As a related art document, there is the following patent document 1 which discloses a structure similar to the above conventional structure.

### RELATED ART DOCUMENT

### Patent Document

Patent document 1: JP-A-2009-295357

### SUMMARY OF THE INVENTION

### Problems to be Solved by the Invention

In the above related example, by making the operation part itself emit light by placing an light emitting part behind the operation part, the position of the operation part can be easily recognized even when this space is in dark. Further, display effect is improved by making the operation part emit light.

However, the display effect is often lowered in the above related example.

In other words, the operation part is actually operated by hand, and the display effect is lowered if the operation part is stained by the operation.

Thus, the present disclosure is intended to improve the display effect.

### Means for Solving the Problems

As one embodiment of the invention, there is provided an electronic apparatus includes a body case having an operation panel at the front side thereof, a reproducing device provided in the body case, and an operation body arranged on the operation panel of the body case in order to operate the reproducing device, the operation body includes an operation part which is inserted through a through hole provided in the operation panel of the body case from the rear side of the operation panel to the front side, a light reflecting part provided between an outer peripheral surface of the operation part and an inner peripheral surface of the through hole, and a light emitting part which is provided behind the light reflecting part, the operation body forms a light guide space between the outer peripheral surface of the operation part and the inner peripheral surface of the light reflecting part, and the front side of the light reflecting part is placed behind the operation panel of the body case.

### Effects of the Invention

The electronic apparatus of the invention as above can improve the display effect.

In other words, the electronic apparatus of the present disclosure does not make the operation part itself to emit light, but makes the light reflecting part that is placed at the outer periphery of the operation part in a light emission state so that the position of the operation part can be recognized. Therefore, for the electronic apparatus of the invention, even if the operation part is stained by the operation, the light emission state of the light reflecting part will not deteriorate, and as a result the display effect can be improved.

Further, because the front side of the light reflecting part in the electronic apparatus of the present disclosure is placed behind the operation panel of the body case, the light reflecting part will not be stained at the time of the operation of the operation part, and from this point the display effect can be improved.

### BRIEF DESCRIPTION OF THE FIGURES

FIG. 1 is a perspective diagram which shows that an in-vehicle electronic apparatus according to one embodiment of the present disclosure is provided inside a vehicle.

FIG. 2 is a front view of the in-vehicle electronic apparatus.

FIG. 3 is a perspective view of the in-vehicle electronic apparatus.

FIG. 4 is an exploded perspective view of the in-vehicle electronic apparatus.

FIG. 5 is a front view of the in-vehicle electronic apparatus.

FIG. 6 is an A-A sectional view of FIG. 5.

FIG. 7 is a B-B sectional view of FIG. 5.

FIG. 8 is a C-C sectional view of FIG. 5.

### EMBODIMENTS OF THE INVENTION

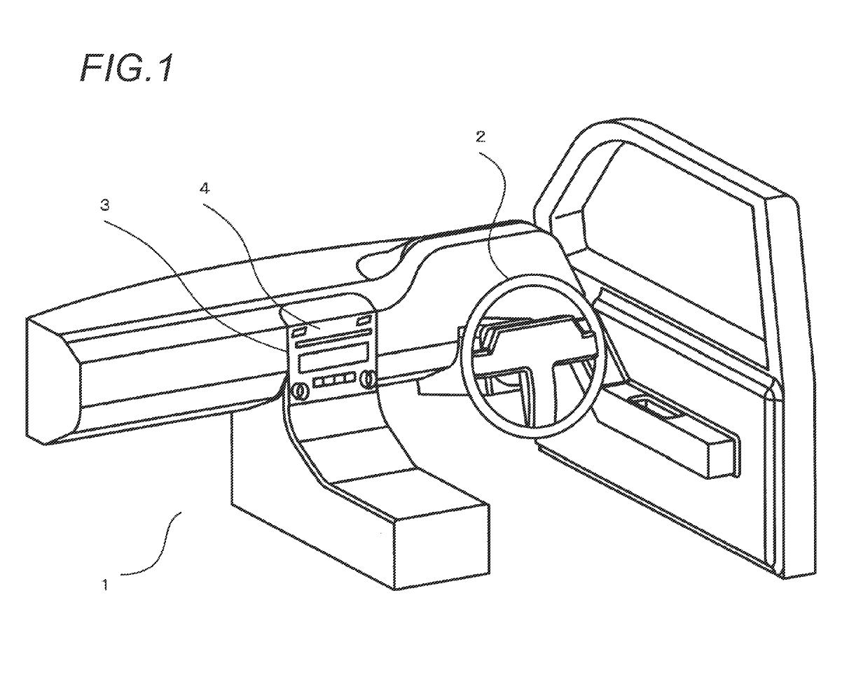

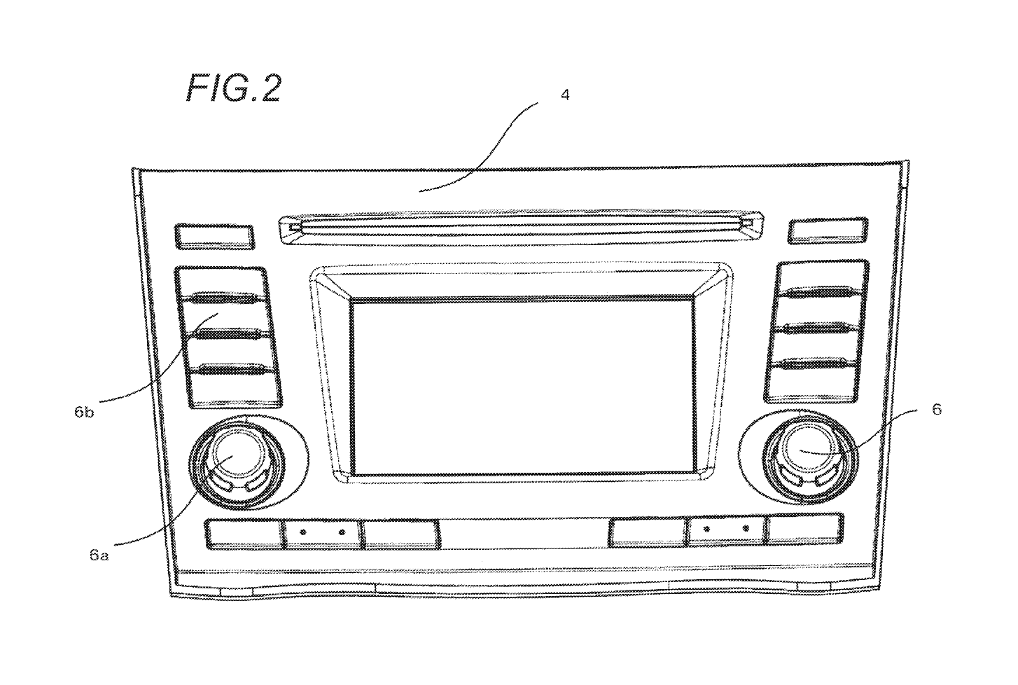

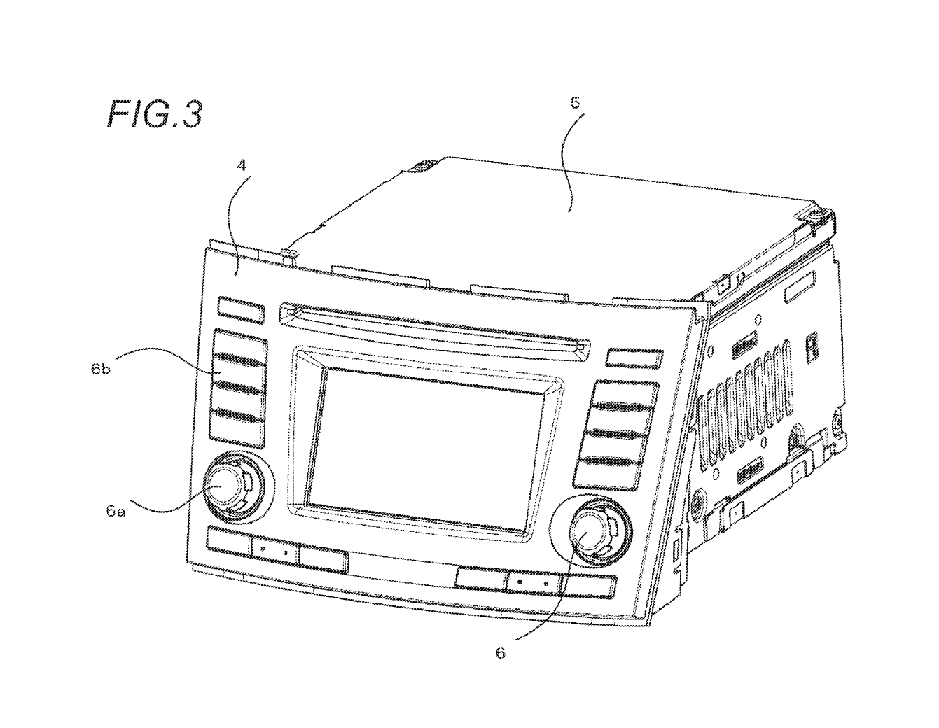

An in-vehicle electronic apparatus 3 according to one embodiment of electronic apparatus of the present disclosure is described. In FIG. 1, a steering wheel 2 is placed in the front of a vehicle inside 1 of an automobile, and the in-vehicle electronic apparatus 3 is placed at the left side of the steering wheel 2. The in-vehicle electronic apparatus 3 has a box-like body case 5 having an operation panel 4 at the front side thereof, and a reproducing device (which, for example, is a radio receiver, a television receiver or a reproducing device of discs, but is not shown in the figures because the reproducing device is an ordinary one.) provided in the body case 5, as shown in FIG. 2 to FIG. 4. In order to operate the reproducing device, operation bodies 6, 6a and 6b which are placed on the operation panel of the body case are included. When the operation body 6 is pushed backwards, the power source can be input, and when the operation body 6 is clockwise swung, the volume can be changed. The operation body 6a can perform the tuning of the radio receiver. The operation body 6b can perform the changing of modes.

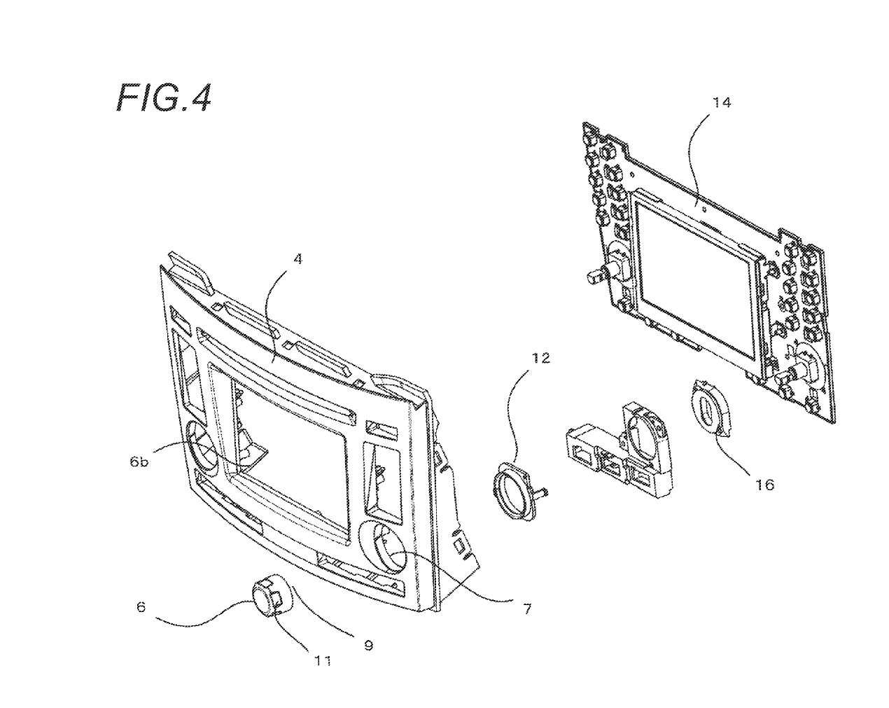

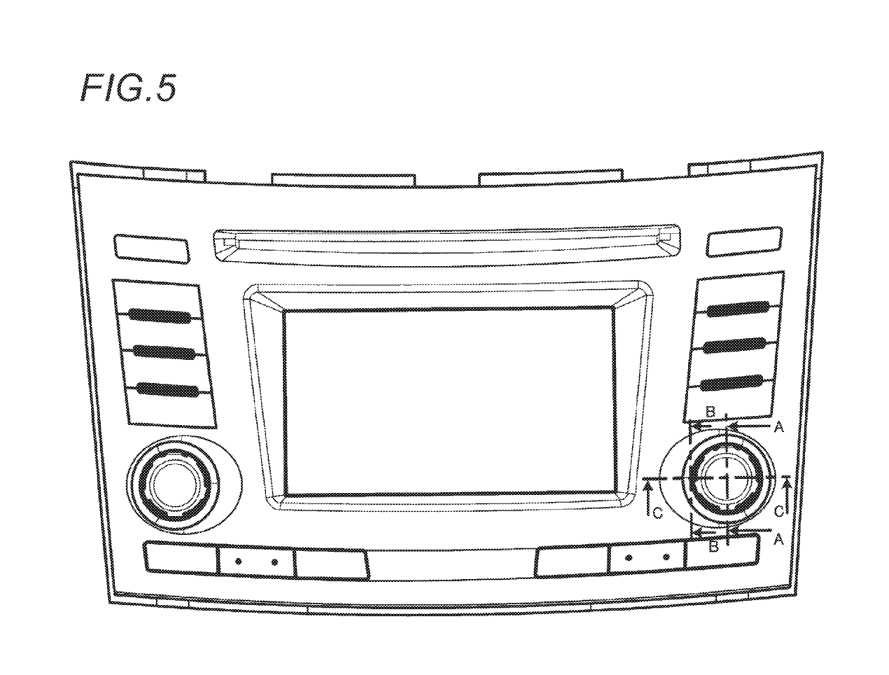

In the embodiment, the operation body 6 is particularly formed as shown in FIGS. 4 to 8.

In other words, a through hole 7 which is penetrated through the operation panel 4 from the rear to the front of the operation panel 4 is formed in a part of the operation panel 4 of the body case 5 in which the operation body 6 is placed, as shown in FIG. 4. An operation part 9 which is inserted into the through hole 7 from the rear to the front of the operation panel 4 is placed in the part of the through hole 7.

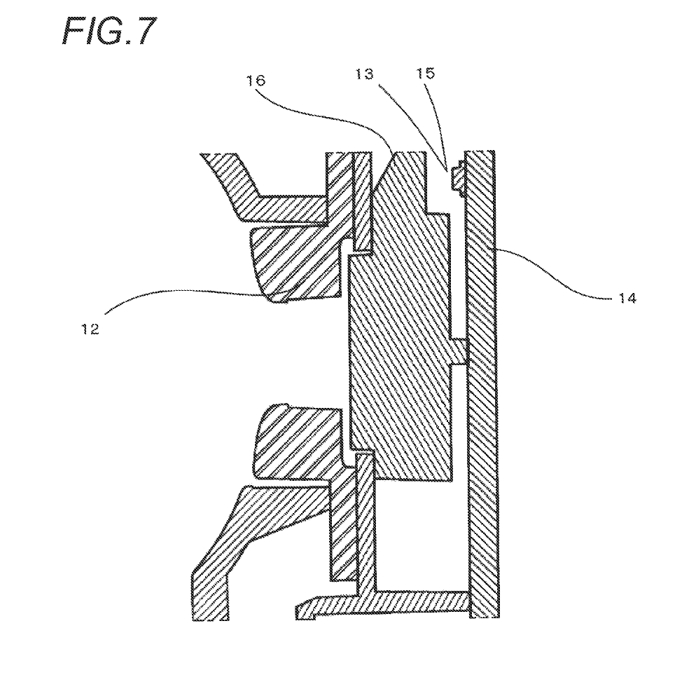

The operation part 9 includes a shaft 10 which is inserted into the through hole 7 from the rear to the front, and a knob 11 which is installed on the front end side of the shaft 10. A ring-like light reflecting part 12 is placed between the outer peripheral surface of the knob 11 which forms the operation part 9 and the inner peripheral surface of the through hole 7. The light reflecting part 12 is formed by being plated on the periphery of a ring-like body made of synthetic resin. The surface of the plated light reflecting part 12 becomes, for example, a silver light reflecting surface. A light emitting part 13 is placed in the body case 5 behind the light reflecting part 12. The light emitting part 13 includes a light emitting element 15 which is placed on the front surface of a board 14, and a light guide plate 16 which is placed in front of the light emitting element 15, as shown in FIG. 7.

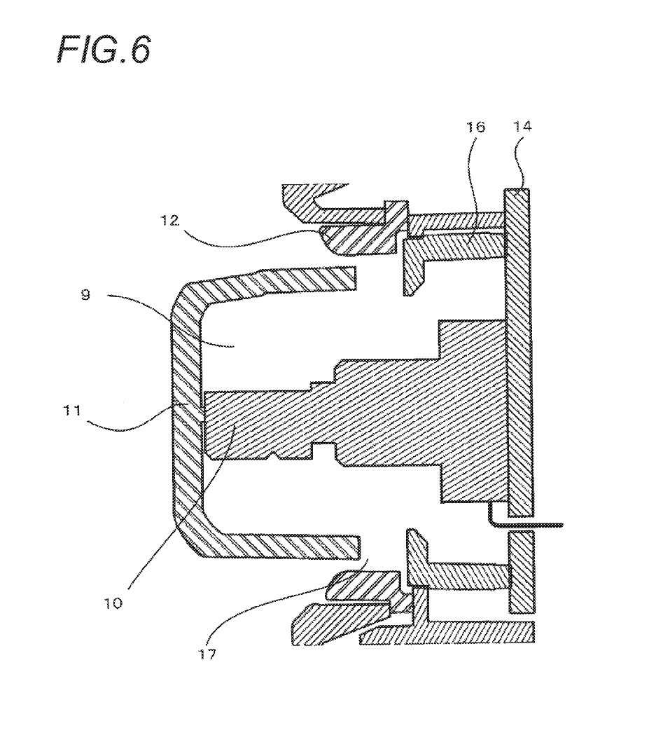

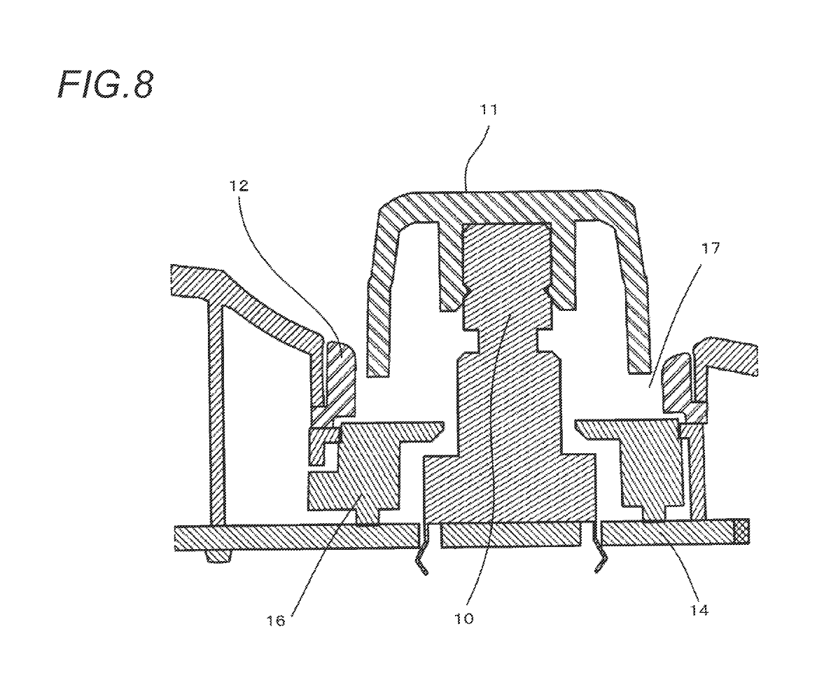

In such a structure, a light guide space 17 is formed between the outer peripheral surface of the knob 11 which forms the operation part 9 and the inner peripheral surface of the light reflecting part 12, as shown in FIGS. 6 and 8. As a result, light of the light emitting part 13 passes through the light guide space 17, and arrives at the front side of the operation panel 4 of the body case 5. At this time, the light reflected by the light reflecting part 12 irradiates the knob 11 from the rear side to the front side. Therefore, the existence of the knob 11 can be recognized definitely.

As mentioned above, the in-vehicle electronic apparatus 3 according to the embodiment has the operation panel 4 having the through hole 7, and the shaft 10, the body case 5, the operation body 6, and the light reflecting part are included inside. The shaft 10 extends from the through hole 7 towards the outside. The body case 5 has the light emitting part 13 that emits light to the outside. The operation body 6 is supported on the front end of the shaft 10 and extends from the inside of the body case 5 through the through hole 7, and at least a part of the operation body 6 extends at the front of the body case 5 beyond the operation panel 4. The light reflecting part 12 is provided between the outer peripheral surface of the operation body 6 and the inner peripheral surface of the body case 5 which forms the through hole 7 and along the inner peripheral surface of the body case 5 behind the operation panel 4, and illuminates the operation body 6 through the through hole 7 from the rear by reflecting light emitted from the light emitting part 13. Due to this arrangement in the in-vehicle electronic apparatus 3 according to the present embodiment, the visibility of the knob 11 that forms one part of the operation body 6 is improved. Due to this arrangement in the in-vehicle electronic apparatus 3 according to the present embodiment, even if the knob 11 is stained at the time of the operation, the light reflecting part 12 which is located behind the operation panel 4 will not be stained. Therefore, even if the knob 11 is being operated, the light reflecting part 12 well reflects the light emitted from the light emitting part 13, and illuminates the operation body 6 through the through hole 7 from the rear. Therefore, in the in-vehicle electronic apparatus 3 according to the present embodiment, the light emission state of the light reflecting part 12 will not deteriorate, and as a result the display effect can be improved.

As mentioned above, the in-vehicle electronic apparatus 3 according to the embodiment does not make the knob 11 which forms the operation part 9 to emit light, but makes the light reflecting part 12 that is placed at the outer periphery of the knob 11 in a light emission state so that the position of the knob 11 can be recognized. Therefore, for the in-vehicle electronic apparatus 3 according to the embodiment, even if the knob 11 is stained at the time of the operation, the light emission state of the light reflecting part 12 will not deteriorate, and as a result the display effect can be improved.

The front side of the light reflecting part 12 in the present embodiment, as found from FIGS. 6 to 8, is placed behind the operation panel 4 of the body case 5. Therefore, the light reflecting part 12 will not be stained at the time of operating the knob 11, and from this point the display effect can be improved.

Although the present disclosure is described in detail with reference to specific embodiments, it is apparent that various modifications and amendments may be made by those skilled in the art without departing from the spirit and scope of the invention.

This application is based on the Japanese patent application (patent application 2010-218174) filed on Sep. 29, 2010, the contents of which are incorporated herein by reference.

### INDUSTRIAL APPLICABILITY

As mentioned above, the electronic apparatus of the present disclosure is a device that does not make the operation part itself to emit light, but makes the light reflecting part that is placed at the outer periphery of the operation part in a light emission state so that the position of the operation part can be recognized. Therefore, even if the operation part is stained at the time of the operation, the light emission state of the light reflecting part will not deteriorate, and as a result the display effect can be improved.

Because the front side of the light reflecting part in the electronic apparatus of the present disclosure is placed behind the operation panel of the body case, the light reflecting part will not be stained at the time of the operation of the operation part, and from this point the display effect can be improved.

Therefore, the electronic apparatus of the present disclosure becomes extremely useful as an in-vehicle electronic apparatus.

### DESCRIPTION OF THE SYMBOLS

1 vehicle inside
2 steering wheel
3 in-vehicle electronic apparatus
4 operation panel
5 body case
6 operation body
7 through hole
9 operation part
10 shaft
11 knob
12 light reflecting part
13 light emitting part
14 board
15 light emitting element
16 light guide plate
17 light guide space

1. An electronic apparatus, comprising:
a body case; and
an operation body that is arranged on an operation panel at the front side of the case body,
wherein the operation body includes:
an operation part which is inserted through a through hole provided in the operation panel of the body case from the rear side of the operation panel to the front side;
a light reflecting part provided between an outer peripheral surface of the operation part and an inner peripheral surface of the through hole; and
a light emitting part which is provided behind the light reflecting part; and
wherein the operation body forms a light guide space between the outer peripheral surface of the operation part and the inner peripheral surface of the light reflecting part.

2. The electronic apparatus according to claim 1, wherein the front side of the light reflecting part is placed behind the operation panel of the body case.

3. An electronic apparatus, comprising
a body case that has an operation panel having a through hole and has a shaft which extends inside the operation panel from the through hole to outside, and an light emitting part which emits light to the outside;
an operation body that is supported on a front end of the shaft and extends from the inside of the body case through the through hole, wherein at least a part of the operation body extends at the front of the body case beyond the operation panel; and
a light reflecting part that is provided between an outer peripheral surface of the operation body and an inner peripheral surface of the body case which forms the through hole and along the inner peripheral surface of the body case behind the operation panel, and illuminates the operation body through the through hole from the rear of the operation body by reflecting light emitted from the light emitting part.
